(19) United States
(12) Patent Application Publication
(10) Pub. No.: US 2002/0109577 A1
(43) Pub. Date: Aug. 15, 2002

(54) Electrical resistor with platinum metal or a platinum metal compound and sensor arrangement with the resistor

(75) Inventors: Thomas Loose, Linsengericht (DE); Martin Turwitt, Bruchkobel (DE); Karl-Heinz Wienand, Aschaffenburg (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Heraeus Electro-Nite International N.V.

(21) Appl. No.: 10/029,646

(22) Filed: Dec. 21, 2001

(30) Foreign Application Priority Data
Dec. 22, 2000 (DE) 100 64 461.9-34

(51) Int. Cl. H01C 3/04

(52) U.S. Cl. 338/25

(57) ABSTRACT

An electrical resistor has a resistance layer containing platinum or a platinum group metal, which is applied to an electrically insulating surface of a substrate, wherein the resistance layer is constructed as a thin layer element and is made of a physical mixture of finely dispersed ceramic and metal. Preferably, the ratio of finely dispersed ceramic to metal lies in a range of about 5 to 50% by weight. Preferably, the finely dispersed ceramic is selected from SiO, Sio₂, Ta₂O₅, MgO, Al₂O₃, and mixtures thereof. The resistor is used as a reference resistor in a sensor (temperature sensor) together with a temperature-dependent measuring resistor, wherein both resistors are arranged on a common substrate.

### BACKGROUND OF THE INVENTION

The invention relates to an electrical resistor with a resistance layer comprising a platinum metal or a platinum metal compound, which is installed on an electrically insulating surface of a substrate. The invention also relates to a sensor arrangement with the resistor.

The sensor should, in particular, be mountable as a flip-chip component, as is known, for example, from German patent DE 44 42 960 C1. Furthermore, a contact arrangement for flip-chip components is known from European patent EP 0 588 609 B1.

From German published patent application DE 31 45 583 A1, a paste is known for printing substrates by means of an elastically deformable stamp, wherein the paste is recommended for applying surface patterns to pre-determined regions of a preferably uneven substrate, which is particularly suitable for a printing process, in which the application takes place by means of an elastically deformable stamp. In the paste the mixing ratio of solid to organic vehicle, given on a weight basis, lies between 6:4 and 8:2, and the organic vehicle comprises 4 to 14% by weight of ethyl cellulose, 73 to 83% by weight of α-terpinol and 5 to 17% of benzyl alcohol. Metal powder and/or ceramic powder and/or glass powder are usable as solids. Accordingly, electrically conductive pastes, resistance pastes and insulating pastes are producible, with which surface patterns of suitable conductivity can be made. The construction of electric measuring elements with such a paste appears relatively expensive.

Furthermore, from German patent DE 40 25 715 C1, a temperature sensor as well as a process for manufacturing temperature sensor elements from ceramic foils is known. The temperature sensor elements are configured such that a PTC resistor consists of several resistor paths applied stack-like one above the other, and consequently have a small planar extension. With the stack arrangement, sufficiently high measuring resistor values and a considerable independence of the same from temperature gradients in exhaust gases can be attained. Nevertheless, the construction of several resistor paths arranged one above the other appears relatively expensive.

Moreover, U.S. Pat. No. 3,565,682 describes an electrical resistor arrangement, which has powder-like dielectric material as well as electrically conducting palladium oxide of the formula PdMO₂, wherein M represents cobalt, chromium, rhodium or a mixture of chromium with rhodium. Preferably, PdCrO₂ or PdRhO₂ are used as palladium oxides. The construction of such resistor arrangements appears relatively expensive.

From German published patent application DE 197 57 258 A1, a temperature-dependent measuring resistor of a temperature sensor is known, which is connected in series with a reference resistor, wherein this series connection is subjected to a constant, applied current. A connection point situated between the two resistors is connected with the N input of a first negative feedback operation amplifier, whose P input is supplied with a direct voltage picked up by a voltage divider. When the temperature in the area of the measuring resistor increases, the potential increases at the output of first operation amplifier connected with the measuring resistor, which supplies the applied constant current, while the potential at the output of the operation amplifier drops when the temperature falls. The temperature-dependent voltage signal emitted at the operation amplifier is fed to the P input of a second operation amplifier connected in series in a subtraction circuit, whose output is connected with a measuring device for measuring the voltage characteristic for the temperature. The temperature sensor has a compact design and is usable up to a temperature of about 300° C. Problematic here are, on the one hand, the relatively complex construction and, on the other hand, the accuracy of the temperature measurement is also dependent, among other things, upon the reference resistor.

### BRIEF SUMMARY OF THE INVENTION

An object of the invention is to manufacture a resistor by means of an improved combination of materials and thin layer methods, which has a substantially constant resistance temperature coefficient (also known as temperature coefficient of resistance or TCR), even under thermal stress. A further object of the invention is to integrate this resistor as a starting resistor or a reference resistor in a network with an electrical temperature measuring resistor in a sensor arrangement, such that an accuracy of about 0.1% and, in addition, a long term stability in a temperature range above 100° C. are possible.

The object is accomplished in a first embodiment in which the resistance layer is constructed as a thin layer element with a layer thickness in a range of about 0.1 μm to 2 μm and comprises a physical mixture of finely dispersed ceramic and platinum metal, wherein the weight ratio of ceramics to metal lies in a range of about 5:95 to 50:50. Preferably, iridium or an iridium-based alloy is used as the metal of the resistance layer. Here, the preferred ratio of finely dispersed ceramic to metal lies in a range of about 5 to 35% by weight.

The object is accomplished in a second embodiment in which the resistance layer is constructed as a thin layer element with a layer thickness in a range of about 0.1 μm to 2 μm and comprises a physical mixture of finely dispersed ceramics and a platinum metal compound. Here, the use of platinum silicide has proven to be particularly advantageous.

It proves to be advantageous that such a resistor makes possible an economical manufacture with simple adjustment. A further advantage is to be seen in that the resistor is to be applied to a substrate together with a temperature-dependent resistor.

Preferably, SiO, SiO₂, Ta₂O₅, MgO, Al₂O₃, or a mixture thereof is used as the finely dispersed ceramic. The substrate is constructed as an electrically insulating ceramic. Preferably, the ceramic of the substrate comprises Al₂O₃.

In an advantageous embodiment the resistance layer has a resistance temperature coefficient (TCR) in a range of about −500 to +1000 ppm/K. It proves to be particularly advantageous that the resistance temperature coefficient (TCR) is adjustable to a value in the region of 0 ppm/K, as is particularly desirable for reference resistors.

In a sensor arrangement the electrical resistor is arranged as a reference resistor together with a temperature-dependent electrical measuring resistor, which is connected in turn with a connection contact pad to an electrical circuit for emitting a temperature signal, wherein a voltage signal falling at the measuring resistor is determined, which behaves at least approximately linearly proportional to its temperature. Here, the measuring resistor is electrically connected with the electric circuit via a further connection contact pad, wherein moreover a mid tap of a series circuit of the measuring resistor and the reference resistor is connected with the electric circuit. The temperature-dependent measuring resistor as well as the reference resistor are respectively arranged together on a substrate with an electrically insulating surface, and the connection contact pads for the measuring resistor and the connection contact pads for the reference resistor are respectively connected with the electric circuit via conductor paths or wire connections, wherein besides the reference resistor, the measuring resistor is also applied as a platinum metal-containing thin layer element. The metal layer of the measuring resistor has a resistance temperature coefficient in a range of about 3500 ppm/K to 3920 ppm/K.

Preferably, the reference resistor is integrated in a network of the sensor arrangement with the measuring resistor. In a preferred embodiment, the measuring resistor has a resistance layer of platinum or a platinum-based alloy.

Preferably, the value of the resistance temperature coefficient is 3850 ppm/K. This value corresponds to the temperature coefficient stated in) IN IEC751 of:

α=0.003850 Ω×Ω⁻¹×°C⁻¹=0.00385(° C.)⁻¹

in accordance with U.S. Pat. No. 4,469,717 for platinum resistance thermometers.

The connected evaluation circuit is executed in silicon technology.

It proves to be advantageous that when using such an integrated reference resistor or starting resistor on a substrate with the measuring resistor, an economical manufacture with simple adjustment, as well as packing and shipping of complete structural components, is made possible. Here, it proves to be particularly advantageous that the integrated reference resistor practically does not change its pre-determined temperature coefficient, even at high thermal stress as a result of temperature measurement.

In addition, space can also be saved on a circuit board for the sensor, whereby the associated network is accommodated in a housing, for example an SMD (Surface-Mounted Device) component with three connections, or in a typical component housing, such as SOT (small outline transistor) or TO (transistor outline) housings.

In a preferred embodiment the measuring resistor has a resistance layer made of platinum, while the metal layer of the reference resistor has a temperature-independent resistance curve. The associated evaluation circuit is preferably executed in silicon technology.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view of an SMD network as a flip-chip component with three connections.

FIG. 2 is a perspective view of the sensor as an SOT component with a plastic extrusion coated lead-frame, which contains the network, which is connected by means of thin wire boring.

FIG. 3 is a perspective view of a dual-in-line housing to which a temperature sensor network is added.

### DETAILED DESCRIPTION OF THE INVENTION

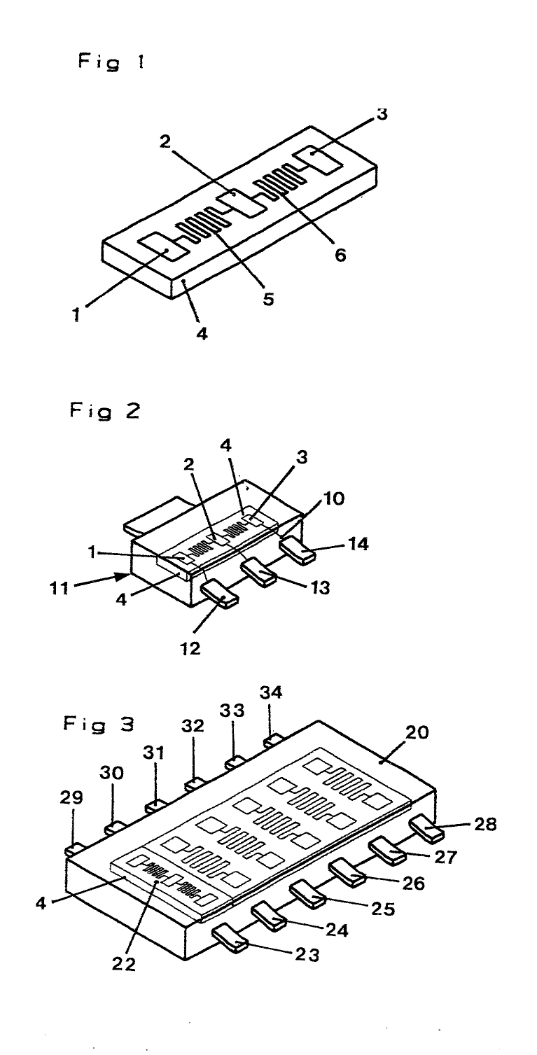

In accordance with FIG. 1, a flip-chip component is provided as substrate 4, on whose surface two resistors are arranged in series, of which the first resistor is provided as a temperature-dependent measuring resistor 5, while the second resistor is used as a starting resistor or reference resistor 6. The two resistors 5 and 6 are electrically connected with each other via a connection contact pad 2, while their outer ends are electrically connected to connection contact pads 1, 3, respectively. Preferably, SnAg10 paste or even AgPd pads or silver-platinum pads are used for connection.

Both resistors 5 and 6 are applied as thin layer elements, wherein measuring resistor 5 is constructed as a platinum thin layer resistor or a thin layer resistor based on a platinum group metal, while the starting resistor or reference resistor 6 has a temperature-independent resistance curve. The reference resistor preferably comprises a physical mixture of finely dispersed ceramic and metal.

Platinum or a platinum group metal is preferably used as the metal for the reference resistor. Moreover, the metal can even comprise a platinum-based alloy with a component or components selected from titanium, nickel and silicon. Owing to the relatively low percentage proportions of the components, this is also spoken of in practice as an “impurity” of the platinum. Furthermore, instead of the metal, a platinum compound, particularly platinum silicide, can be used.

The reference resistor is applied just as the measuring resistor, preferably by vapor deposition techniques, to the surface of the substrate 4. Installation preferably takes place according to the principles of SMD technology.

In accordance with FIG. 2, an SOT component 11 is provided with a plastic extrusion coated lead-frame, in which a resistor network (corresponding to FIG. 1) is imbedded in the SOT housing. The resistor network is connected via its connection contact pads 1, 2 and 3 by means of thin wire bonding 10 to the outwardly projecting contacts 12, 13, 14 of the encapsulated lead-frame. Such an arrangement is preferably used in automotive electronics.

In accordance with FIG. 3, the temperature sensor network 22, including a measuring resistor and reference resistor, is applied to a dual-in-line housing 20, which contains a plastic extrusion coated lead-frame, which has the outer contacts 23 to 28 as well as connection contacts 29 to 34 on the opposite side. The temperature sensor network 22 can here likewise be connected via bond wires with contacting connections, for example connection 23 or connection 29 for the purpose of evaluating a temperature measurement. The use of a dual-inline housing can also take place in connection with further resistors, for example measuring resistors, wherein their contact pads are connected, just like the contact pads of the temperature sensor network 22, with the connection contacts 23 to 34 projecting out of the dual-in-line housing 20. Here, it is also possible to construct a network with a plurality of sensors. The use of a dual-in-line housing has the advantage, in particular, that one is dealing here with a commercially available product, which can be obtained at low prices.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An electrical resistor comprising a resistance layer containing a platinum metal, the resistance layer being applied on an electrically insulating surface of a substrate, wherein the resistance layer is constructed as a thin layer element having a layer thickness in a range of about 0.1 μm to 2 μm, wherein the resistance layer comprises a physical mixture of finely dispersed ceramic and metal, and wherein the weight ratio of ceramic to metal lies in a range of about 5:95 to 50:50.

2. The electrical resistor according to claim 1, wherein the metal of the resistance layer is selected from the group consisting of iridium and iridium-based alloys.

3. The electrical resistor according to claim 2, wherein the resistance layer has a resistance temperature coefficient (TCR) in a range of about −500 to +1000 ppm/K, and wherein the weight ratio of finely dispersed ceramic to iridium lies in a range of about 5:95 to 8:92.

4. The electrical resistor according to claim 1, wherein the weight ratio of finely dispersed ceramic to metal lies in a range of about 5 to 35%.

5. The electrical resistor according to claim 1, wherein the finely dispersed ceramic is selected from the group consisting of SiO, SiO₂, Ta₂O₅, MgO, and Al₂O₃.

6. The electrical resistor according to claim 1, wherein the substrate comprises an electrically insulating ceramic.

7. The electrical resistor according to claim 6, wherein the ceramic of the substrate comprises Al₂O₃.

8. The electrical resistor according to claim 7, wherein the resistance layer has a resistance temperature coefficient (TCR) of about 0 ppm/K

9. An electrical resistor comprising a resistance layer containing a platinum metal, the resistance layer being mounted on an electrically insulating surface of a substrate, wherein the resistance layer is constructed as a thin layer element having a layer thickness in a range of about 0.1 μm to 2 μm, and wherein thin layer element comprises a physical mixture of finely dispersed ceramics and a platinum metal compound.

10. The electrical resistor according to claim 9, wherein the platinum metal compound comprises platinum silicide.

11. The electrical resistor according to claim 9, wherein the finely dispersed ceramic is selected from the group consisting of SiO, SiO₂, Ta₂O₅, MgO, and Al₂O₃.

12. The electrical resistor according to claim 9, wherein the substrate comprises an electrically insulating ceramic.

13. The electrical resistor according to claim 12, wherein the ceramic of the substrate comprises Al₂O₃.

14. The electrical resistor according to claim 13, wherein the resistance layer has a resistance temperature coefficient (TCR) of about 0 ppm/K.

15. A sensor arrangement having an electrical resistor according to claim 1, wherein the electrical resistor is arranged as a reference resistor (6) in a sensor together with a temperature-dependent electrical measuring resistor (5) which is connected via connection contact pads (1, 2) to an associated electric circuit for emitting a temperature signal, wherein a voltage signal falling on the measuring resistor (5) is determined, which behaves at least approximately linearly proportional to the temperature of the signal, wherein the measuring resistor is electrically connected with the electric circuit via a further connection contact pad, wherein a mid tap of a series connection of the measuring resistor and the reference resistor is connected with the electric circuit, and the temperature-dependent measuring resistor (5) and the reference resistor (6) are respectively arranged on a substrate having an electrically insulating surface and the connection contact pads for the measuring resistor and the connection contact pads for the reference resistor are connected respectively via conductor paths or wire connections with the electric circuit, wherein both the reference resistor and the measuring resistor are applied as platinum metal-containing thin layer elements, and the metal layer of the measuring resistor has a resistance temperature coefficient in a range of about 3500 ppm/K to 3920 ppm/K.

16. The sensor arrangement according to claim 15, wherein the reference resistor (6) is integrated in a network with the temperature-dependent measuring resistor (5).

17. The sensor arrangement according to claim 15, wherein the measuring resistor (5) comprises a resistance layer made of platinum or a platinum-based alloy.

18. The sensor arrangement according to claim 17, wherein the resistance temperature coefficient (TCR) of the resistance layer of the measuring resistor (5) has a value of 3850 ppm/K.

19. The sensor arrangement according to claim 15, wherein the associated electric circuit is an evaluation circuit executed in silicon technology.
